(19) United States
(12) Patent Application Publication
(10) Pub. No.: US 2006/0186573 A1
(43) Pub. Date: Aug. 24, 2006

(54) System for fabricating sleeved ultra violet lamps

(76) Inventor: Harrell Page Ellis, Irving, TX (US)

Correspondence Address: George R. Schulz;Schultz & Associates, P.C., Suite 1200, 5400 LBJ Freeway, Dallas, TX, 75240, US

(21) Appl. No.: 11/062,078

(22) Filed: Feb. 21, 2005

(51) Int. Cl. B29C 61/00; B29C 41/00

(52) U.S. Cl. 264/230

(57) ABSTRACT

The present invention generally provides for an apparatus and method for heat shrinking an envelope of heat shrinkable sleeving material into circumferential and longitudinal conformity with a substrate product enclosed by the sleeving material. The present invention provides for a sleeve gripping/holding tool and sleeving table apparatus combination used during the heat shrinking method of the invention for enabling the tensioning and positioning of a heat shrinkable sleeve during the heat application process.

### FIELD OF INVENTION

The present invention relates generally to methods for heat-shrinking an enclosure of protective fluoropolymer shrinkable material into conformity over an ultraviolet (UV) lamp or quartz tubing for use in various applications. Furthermore, the present invention also relates to tools for holding and tensioning heat shrinkable sleeve material.

### BACKGROUND OF THE INVENTION

UV lamps are used in various applications to sterilize products and fluids, among other things. Protective sleeves are needed for the lamps to prevent contamination of the products and fluids.

Heat shrinkable materials such as fluorinated ethylene propylene (FEP), polytetrafluoroethylene (PTFE), perfluoromethylvinylether (MFA) co-polymer, and tetrafluoroethylene hexafluoropropylene vinylidene fluoride (THV) have gained substantial acceptance in the industry for protective sleeves for lamps, including UV lamps.

Methods of covering UV lamps are shown in U.S. Pat. No. 6,741,024 B2 to Burgess, et al., U.S. Pat. No. 3,753,036 to Roche, U.S. Pat. No. 4,449,071 to Yokoyama, U.S. Pat. No. 6,043,600 to Sica and U.S. Pat. No. 6,452,325 B1 to Dupont.

### BRIEF DESCRIPTION OF THE DRAWINGS

Many of the aspects of the invention can be better understood with reference to the following drawings. The components in the drawings are not necessarily to scale, emphasis instead being placed upon clearly illustrating the principles of the present invention.

FIG. 1 is a cross-section view of a vessel employing sleeved lamps for decontamination;

FIG. 2 is a side view of a conveyor system employing sleeved lamps for decontamination;

FIG. 3 is a partial end cross-section view of a sleeved lamp showing coverage of lamp end components;

FIG. 4 is a graph showing percent transmission of ultraviolet light through various sleeving materials used in the invention;

FIG. 5 is a cross section view of a sleeved lamp showing open lamp end components;

FIG. 6 is a partial central cross-section view of a sleeved lamp;

FIG. 7 is an isometric view of the preferred embodiment of the invention;

FIG. 8 is an isometric view of an alternate embodiment of the invention.

### DETAILED DESCRIPTION OF THE INVENTION

The present invention provides both an apparatus and method for manufacturing of sleeved lamps.

A heat shrinkable sleeve is placed as a protective barrier over the UV lamp in either application, so that it lies between the UV lamp and the fluid stream or product. The heat shrinkable sleeve significantly reduces particulate fouling. The sleeve encapsulates the lamp so that, in the event of damage or breakage of the lamp, the contents of the lamp and the pieces of the tube remain encapsulated within the sleeve.

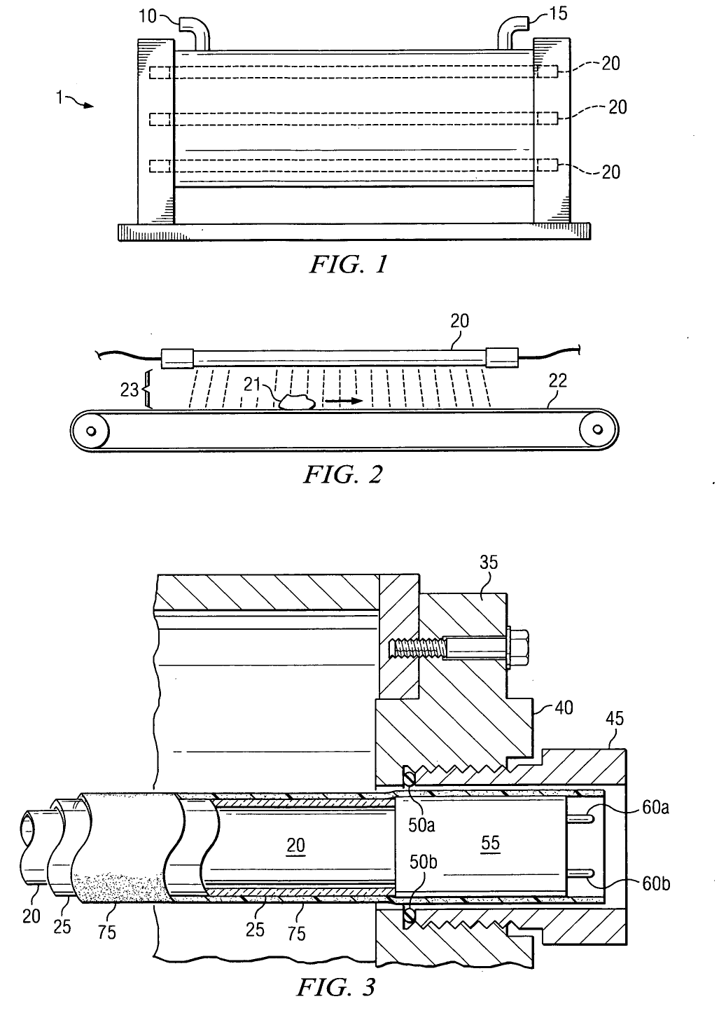

For example, FIG. 1 depicts an illustrative side view of a decontamination vessel 1. Vessel 1 is generally constructed in a cylindrical in shape and includes inlet 10 and outlet 15 connections. In use, liquid or gas flowing through vessel 1 are decontaminated by UV lamps 20 enclosed within vessel 1. The UV lamps contained within vessel 1 are sleeved with a protective material utilizing the apparatus and method of the present invention.

For example, FIG. 2 depicts an illustrative side view of a decontamination process for products. The decontamination process comprises a conveyor system 22 on which a product 21 is carried. Product 21 is transported by conveyor system 22 under UV lamp 20 within a distance 23 so as to provide sufficient radiation to decontaminate product 21. In this application, UV lamp 20 must be sleeved with a transparent or translucent sleeve.

For example, FIG. 6 shows a cross sectional view of UV lamp 20 within quartz tube 25 having heat shrinkable sleeve 75 applied. Inner wall 62 of quartz tube 25 is separated from UV lamp 20 by air space 80. The method provides that “twists” and air pockets between the sleeve and the tube be eliminated.

FIG. 3 illustrates a preferred technique for mounting a sleeved protective quartz tube 25 in vessel 1. End fitting 40 covers the end of vessel 1 and has overlapping flange 35 which provides a fluid tight seal. End fitting 40 is typically bolted to vessel 1. End fitting 40 is preferably made from aluminum, steel or similar material. At the proper location for each UV lamp 20, quartz tube 25 extends through fitting 40. UV lamp 20 is contained within quartz tube 25. Jam nut 45 is threaded into end fitting 40. O-rings 50a and 50b are used to seal around quartz tube 25 and may include additional washers and sealing devices (not shown) as appropriate. Quartz tube 25 and lamp end 55, encased by heat shrinkable sleeve 75, extends into jam nut 45. Electrical connecting pins 60a and 60b extend from lamp end 55 of UV lamp 20 and are used to connect a power source to UV lamp 20.

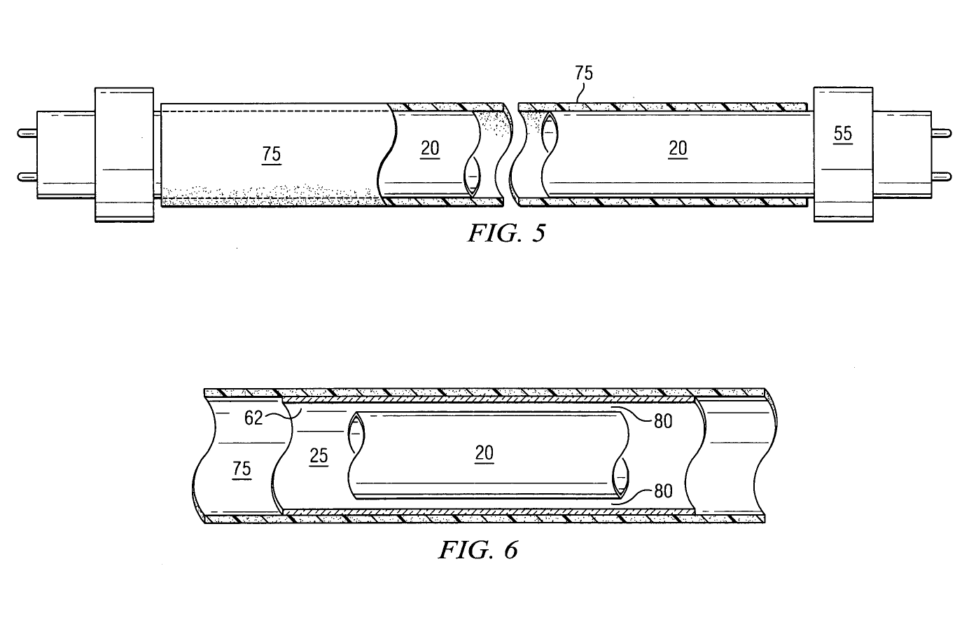

In another embodiment, FIG. 5 depicts a cross-sectional view of heat shrinkable sleeve 75 covering UV lamp 20. In this embodiment, heat shrinkable sleeve 75 is applied directly to UV lamp 20 as opposed to the quartz tube. Also, the sleeve does not extend over lamp end 55.

In a preferred form, heat shrinkable sleeve 75 is made in a hollow flexible cylinder supplied in different lengths with circumferential dimensions close to those of UV lamp 20 or quartz tube 25.

The dimensions of heat shrinkable sleeve 75 chosen in the preferred embodiment depend on the UV lamp to be covered. In each instance, the inside diameter of the sleeve before shrinking should be at least 2% larger than the outside diameter of the lamp to be covered. The linear dimension of the shrinkable sleeve before shrinking should be approximately 20% longer than the UV lamp to be covered. In a preferred embodiment, the linear dimension of the sleeve is approximately 4 inches longer than the UV lamp to be covered.

Thicknesses of the material used for the sleeve can range from about 0.01 inches to about 0.1 inches with a preferred range of between 0.02 inches and 0.06 inches. Tolerances of plus or minus 20% are acceptable.

The recovered diameter of heat shrinkable sleeve 75 after heat shrinking should be less than outer diameter of UV lamp 20, quartz tube 25 or other object to be covered to allow for a secure fit. In the preferred embodiment, the recovered diameter should be no less than 2% smaller than the object to be covered.

In another preferred embodiment, heat shrinkable sleeve 75, while hollow and cylindrical is supplied flat on a roll. The roll is generally disk shaped and is supported on a spool and spindle attached to the table (not shown). In this embodiment, a length of heat shrinkable sleeve 75 is dispensed according to the required dimensions of the tube. In the preferred embodiment, the length of the sleeve should be between 2 inches and 20 inches longer than the tube to be covered.

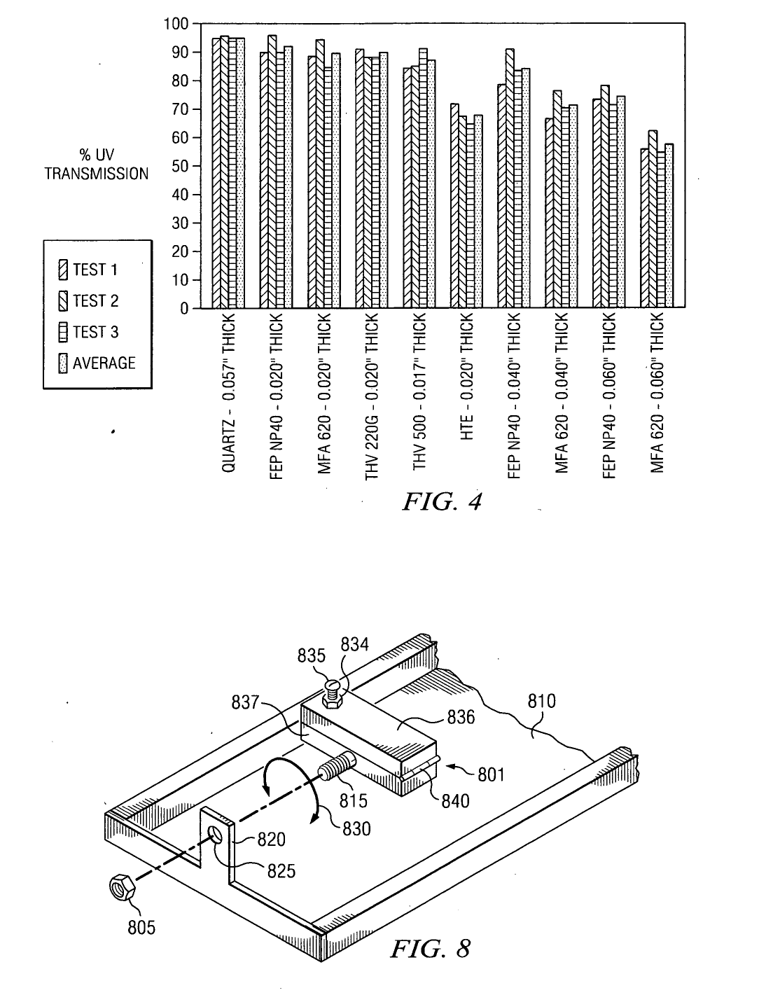

Heat shrinkable sleeve 75 in the preferred embodiment is chosen from a range of materials such as fluorinated ethylene propylene (FEP), polytetrafluoroethylene (PTFE), perfluoromethylvinylether (MFA) co-polymer, and tetrafluoroethylene hexafluoropropylene vinylidene fluoride (THV). Transparent or translucent materials with high UV transmission percentages are preferred. A known approximate transmission percentage of ultraviolet light through various thicknesses of various materials which can be used in the invention are set out in FIG. 4 for reference.

Other transparent or translucent materials with high UV transmission rates are acceptable, and therefore are preferable in many circumstances.

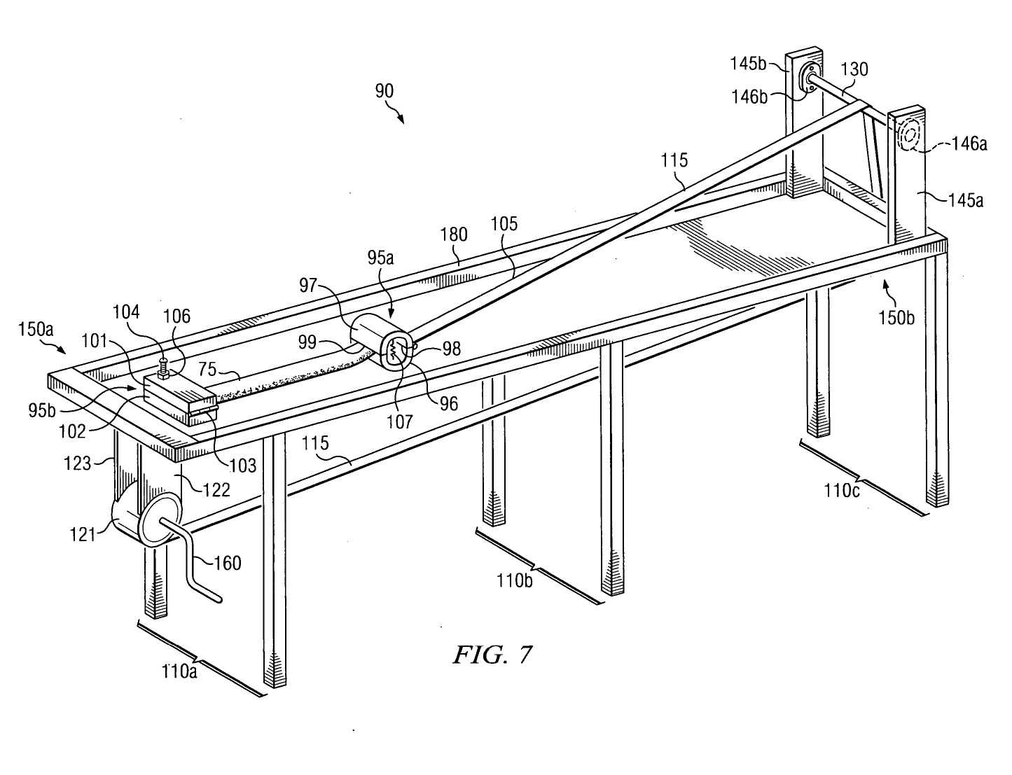

FIG. 7 shows a sleeving table 90 according to the present invention. Work surface top 105 of sleeving table 90 is mounted to work surface frame 180 and has a width of about 12½ inches, a height above the floor surface of about 36 inches, and a length of about 98 inches. Top 105 is preferably made from a light yet rigid material such as a metallic material. Work surface frame 180 is made of aluminum channel. Of course, other materials will suffice if they provide sufficient rigidity. Top 105 is supported in a generally horizontal position by vertical support legs 110a, 110b, and 110c. In the preferred embodiment, the legs have a height of about 36 inches. Vertical support legs 110a, 110b, and 110c can be folded underneath work surface frame 180 into a transport/storage position for transport or storage by locking hinges, thereby permitting easy movement to and from different locations.

Clamps 95a and 95b are provided to grip the sleeving material. The clamps are made of metallic materials such as steel or aluminum for durability, resiliency, and strength. The clamps exert a grip strength sufficient to hold heat shrinkable sleeve 75 when a tension force is applied to tensioning cable 115.

Clamp 95a is mounted to tensioning cable 115 in the preferred embodiment via a standard U-bolt cable clamp (not shown). Clamp 95a in the preferred embodiment is comprised of two hinged jaws 96 and 97. Hinged jaws 96 and 97 each are provided with a gripping surface 98 and 99. Each gripping surface can be serrated or made from a material with a high coefficient of friction such as rubber or sandpaper. The jaws are maintained in a closed position by tension spring 107. Tension spring 107 provides adequate tension to hold heat shrinkable sleeve 75 when a tension force is applied to tensioning cable 115. In another embodiment, clamp 95a can be attached to tensioning cable 115 through a coupling (not shown) capable of rotation about the axis of the cable.

Clamp 95b is mounted to sleeving table end 150a on work surface top 105. In one preferred embodiment, clamp 95b is rigidly attached to work surface top 105 by a process such as welding. Other means of rigid attachment such as bolting the clamp to the table is also possible and acceptable. Clamp 95b is constructed from resilient plates 101 and 102. The resilient plates of the preferred embodiment are fabricated from aluminum channel stock. Of course, other stiff resilient materials will work as well. The plates are provided with rubber surfaces (not shown) on each inside surface which contact the sleeve during use. The plates are attached through hinge 103 and cooperating pressure nut 105 and screw 104. In operation, pressure nut 105 and screw 104 are advanced, creating pressure between plates 101 and 102 to hold the sleeve.

FIG. 8 shows a second preferred embodiment of clamp 95b. In this preferred embodiment, clamp 801 is connected to table 810 through the cooperation of shaft 815, retaining nut 805 and plate 820. Plate 820 is provided with hole 825 of sufficient diameter to allow the passage and rotation of shaft 815. Retaining nut 805 is fixed to shaft 815 and is provided with a diameter larger than hole 825. During use, this embodiment allows the rotation of clamp 801 about the axis of shaft 815 as shown by arrow 830. The clamp and plate in the preferred embodiment are dimensioned to allow complete rotation of the clamp.

Clamp 801 is constructed from resilient plates 836 and 837. The resilient plates of the preferred embodiment are fabricated from aluminum channel stock. Of course, other resilient materials will work as well. The plates are provided with rubber jaws (not shown) on each inside surface which contact the sleeve during use. The plates are attached through hinge 840 and cooperating pressure nut and screw 835. In operation, pressure nut and screw 835 are advanced, creating pressure between plates 836 and 837 to hold the sleeve. In the preferred embodiment, shaft 815 is rigidly connected to either plate 836 or 837.

Returning to FIG. 7, winch 121 is rigidly mounted to the bottom of the sleeving table with supports 122 and 123. The supports are rigid and provide adequate support to prevent movement of the winch during operation. Tensioning cable 115 is connected to the spool (not shown) of winch 121. Handle 160 is used to operate the winch to apply tension to tensioning cable 115. Winch 121 is fitted with a ratchet and pawl assembly having a release (not shown). The release has two positions. In the first position, tension can be maintained on tensioning cable 115 without a force being applied to handle 160. In the second position, a continual force must be applied to handle 160 to maintain tension, but the tension can be varied.

Tensioning cable 115 in an alternative embodiment can be a flat rubber belt or belt of other material which expands little under tension loads. In another preferred embodiment, the belt can be notched or marked in order to index the distance that the belt moves and/or the linear expansion of the sleeve.

An electric motor and gearbox and controller can be substituted for winch 121 in a preferred embodiment. In either case, the tension force applied in tensioning cable 115 is about 5 to 50 lbs., depending on the material used for the heat shrinkable sleeve. In one preferred embodiment, a variable tension is applied to control nonlinear shrinkage or to vary the final thickness of the sleeve.

A pulley (not shown) is rigidly suspended from the table near end 150b and serves as a block to redirect the cable vertically. A rotatable rod 130 is provided to redirect the cable back toward sleeving table end 150a. In the preferred embodiment, the rod has a diameter of about and inch. Rod 130 is rotatably mounted between supports 145a and 145b in bearing blocks 146a and 146b at a height of about 11 inches as measured from work surface top 105. The pulley and rotatable rod cooperate to redirect the tension and reverse the direction of the tension force by about 180 degrees. Depending on the lamp used, the angle of redirection can be grater than 180 degrees.

The winch, in combination with the cable, pulleys and a rotatable rod are utilized to exert tensioning forces on heat shrinkable sleeve 75. The physical positions of the winch, handle, pulley, rod and clamps in relation to the table allow the process of the invention to be carried out by a single person if need be.

The method of the present invention is conducted in the following manner. The material for heat shrinkable sleeve 75 is selected based on the desired percentage of transmission of UV light, the final dimensions after heating, the diameter before heating, the diameter of the UV lamp and on the extent of linear coverage desired. The diameter of the sleeve must accommodate the diameter of the UV lamp before shrinking but cannot be so large as to prevent an air tight fit after shrinking to the recovered diameter. The UV lamp is then placed in the sleeve. The sleeve should overlap the ends of the UV lamp by the proscribed amount.

Clamps 95a and 95b are then affixed onto the overlapping ends of heat shrinkable sleeve 75. Tension is applied by winch 121. In one embodiment, the tension force is adjusted and maintained constant to provide uniform radial contraction of the sleeve and to prevent axial contraction of the sleeve. In another embodiment, a variable tension is applied by the winch to adjust for the nonlinear rate of shrinkage or expansion of the sleeve during the process.

Heat is then evenly applied with a suitable heat source over the length and outer diameter of heat shrinkable sleeve 75 until heat shrinkable sleeve 75 is evenly and consistently applied to the surface of the UV lamp. In one embodiment, the heat source is a heat gun having a voltage and wattage rating of about 120 VAC and about 1200 W with a range of 100 to 150 watts, and a temperature capability from about 250 to about 1100 degrees Fahrenheit. The heat gun may be manually used to supply even heating of the sleeve or may be mounted to the table for ease of use. In another alternate embodiment, a convection oven can be used to apply the required heat. In yet another embodiment, radiant energy sources such as infrared lights can be used.

In one embodiment, the UV lamp is periodically rotated during the process while simultaneously applying heat to provide uniform shrinkage and to help prevent air bubbles between heat shrinkable sleeve 75 and the lamp.

Application of the combination of hot air and positional tensioning causes heat shrinkable sleeve 75 to shrink into an airtight fit with the configuration of the lamp, lamp end 55 and electrical connecting pins 60a and 60b, as desired.

After sufficient cooling, the excess sleeve material is removed from the UV lamp. The process is complete when the UV lamp is firmly sealed with heat shrinkable sleeve 75.

It should be understood that the present apparatus and method disclosed herein is not limited to use with and application to UV lamps or quartz tubes. The disclosed sleeving table apparatus and method for application of such sleeving can be used for application of heat shrinkable sleeving to any substrate product desired.

It will therefore be readily understood by those persons skilled in the art that the present invention is susceptible of broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

This invention is susceptible to considerable variation in its practice. Accordingly, this invention is not limited to the specific exemplifications set forth herein above. Rather, this invention is within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part of the invention under the doctrine of equivalents.

What is claimed is:

1. A system for applying a heat shrink sleeve to a substrate product comprising:
a heat source means, adjacent to the sleeve, for applying heat to the sleeve;
a releasable gripping means, attached to the sleeve, for holding the sleeve during application of the heat source; and
a variable tensioning means, attached to the gripping means, for applying a tensioning force to the sleeve along a longitudinal axis of the sleeve.

2. The system of claim 1 wherein the substrate product is selected from the group consisting of UV lamps and quartz tubes.

3. The system of claim 1 wherein the heat shrinkable sleeve is a Fluoropolymer material.

4. The system of claim 3 wherein the heat shrinkable sleeve has a thickness of from about 0.01 inches to about 0.1 inches.

5. The system of claim 3 wherein the heat shrinkable sleeve has a thickness of between about 0.02 inches and about 0.06 inches.

6. The system of claim 3 wherein the Fluoropolymer material is selected from the group consisting of FEP NP40, MFA 620, THV 220G, THV 500, THE and PTFE.

7. The system of claim 1 wherein the tensioning means further comprises a tensioning cable and winch capable of producing a variable tension.

8. The system of claim 1 wherein the gripping means comprises a rotating clamp means for rotation of the sleeve.

9. The system of claim 1 wherein the gripping means further comprises a hinged clamp.

10. The system of claim 1 wherein the sleeve is cylindrical and dimensioned to fit over the substrate product.

11. The system of claim 1 wherein the gripping means comprises a clamp having a gripping surface adjacent to the sleeve.

12. The system of claim 11 wherein the clamp further comprises a non-metallic gripping surface.

13. The system of claim 11 wherein the gripping surface is serrated.

14. The system of claim 11 wherein the gripping means further comprises a grip adjustment means for adjusting a holding force exerted on the sleeve.

15. The system of claim 1 wherein the tensioning means further comprises a power means for generating the tension force.

16. The system if claim 15 wherein the power means is a powered gear box.

17. The system of claim 15 wherein the power means is an electric motor means.

18. The system of claim 1 wherein the tensioning force is between about 5 and 50 lbs.

19. The system of claim 15, wherein the tensioning means further comprises a belt.

20. The system of claim 15 wherein the belt further comprises an indexing means for tracking the movement of the belt.

21. The system of claim 15 wherein the tensioning means further comprises a pulley means for redirecting the tensioning force.

22. An apparatus for radially shrinking a sleeving material onto a substrate comprising:
a heater adjacent to the material;
a clamp releasably connected to the material;
a tensioning device functionally connected to the clamp; and
wherein the tensioning device is variably adjustable to provide a continuous tension force to the clamp.

23. The apparatus of claim 22 wherein the continuous tension force is between about 5 and 50 lbs.

24. The apparatus of claim 22 wherein the continuous tension force is varied to provide uniform radial contraction of the sleeving material.

25. The apparatus of claim 22 wherein the continuous tension force is varied to prevent axial contraction of the sleeving material.

26. The apparatus of claim 22, wherein the clamp is axially rotatable.

27. The apparatus of claim 22 wherein the heater is movable relative to the material

28. The apparatus of claim 22 wherein the heater is radiant.

29. The apparatus of claim 22 wherein the heater is convective.

30. The apparatus of claim 22 wherein the heater provides a power of between about 1000 watts and 1300 watts.

31. The apparatus of claim 22 wherein the heater provides a temperature of between about 250 degrees and 1100 degrees Fahrenheit.

32. The apparatus of claim 22 wherein the sleeving material is about 20% longer than the substrate.

33. The apparatus of claim 22 wherein the sleeving material is between about 2 inches and about 10 inches longer than the substrate.

34. The apparatus of claim 22 wherein the substrate is a UV lamp.

35. The apparatus of claim 22 wherein the substrate is a quartz tube.

36. The apparatus of claim 22 wherein the sleeving material has a recovered diameter of about 5% less than the diameter of the substrate.

37. The apparatus of claim 22 wherein the sleeving is a Fluoropolymer.

38. The apparatus of claim 22 wherein the tensioning means is manual.

39. The apparatus of claim 22 wherein the tensioning means is powered.

40. The apparatus of claim 22 wherein the material is generally cylindrical and the substrate is generally cylindrical and wherein the diameter of the material before shrinking is at least 2% larger than the diameter of the substrate.

41. The apparatus of claim 40 wherein the recovered diameter of the material is not less than 2% smaller than the substrate.

42. The apparatus of claim 22 wherein the substrate is sized to fit over an electrical connection block of the substrate.

43. A method of shrinking a heat shrinkable material onto a product, the method comprising the steps of:
sizing the material;
placing the material onto the product;
applying heat to the material;
applying a continuously variable tension to the material in order to provide generally uniform radial contraction and prevent axial contraction of the material.

44. The method of claim 43 wherein the product is sealed but for electrical connections.

45. The method of claim 43 wherein the step of applying further comprises the step of rotating the material about an axis of the product.

46. The method of claim 43 wherein the heat applied is applied convectively.

47. The method of claim 43 wherein the heat applied is applied radiatively.

48. The method of claim 43 wherein the tension force is indexed.

49. An apparatus for applying a heat shrinkable material tube to a substrate comprising:
a clamping means for holding the heat shrinkable material;
a tension transmission means, attached to the clamping means, for transmitting a tension force to the clamping means;
a tension generating means, attached to the tension transmission means and directly adjacent to the clamping means, for creating the tension force;
a heating means, adjacent to the heat shrinkable material, for heating the heat shrinkable material.

50. The apparatus of claim 49 further comprising a tension redirection means, rotatively supporting the tension transmission means, for changing the angle of the tension force.

51. The apparatus of claim 50 wherein the angle is greater than 90 degrees.

52. The apparatus of claim 50 wherein the angle is greater than 180 degrees.

53. The apparatus of claim 49 wherein the clamping means allows rotation of the heat shrinkable material about a linear axis of the heat shrinkable material.

54. The apparatus of claim 49 wherein the tension force is variable.

55. The apparatus of claim 49 wherein the tension force is static.

56. The apparatus of claim 49 wherein the sleeving material is about 4 inches longer than the substrate.

57. The apparatus of claim 49 wherein the tension transmission means further includes an indexing means for monitoring dimensional changes in the heat shrinkable material.

58. The apparatus of claim 49 wherein the tension transmission means includes a belt.

59. The apparatus of claim 49 wherein the tension transmission means includes a cable.

60. The apparatus of claim 49 wherein further comprising a spool means, adjacent to the clamping means, for deployment of the heat shrinkable material.
